(19) United States
(12) Patent Application Publication
(10) Pub. No.: US 2011/0206598 A1
(43) Pub. Date: Aug. 25, 2011

(54) Preparation of hydrogen fluoride from fluorspar or calcium fluoride containing waste material

(75) Inventors: Helmut Grass, Bad Friedrichshall (DE); Matthias Hengst, Massenbachhausen (DE); Johannes Eicher, Sehnde (DE)

(73) Assignee: SOLVAY FLUOR GMBH, Hannover (DE)

(21) Appl. No.: 12/937,828

(22) PCT Filed: Apr. 21, 2009
(86) PCT No.: PCT/EP09/54752

§ 371 Date: May 10, 2011

(30) Foreign Application Priority Data
Apr. 22, 2008 (EP) 08154910.7

(51) Int. Cl. C01B 7/19

(52) U.S. Cl. 423/482

(57) ABSTRACT

A process for the preparation of HF and anhydrite from reaction of calcium fluoride in the form of fines and sulfuric acid. The content of sulfuric acid is kept in a range where no agglomeration occurs. In such process, dust originating from natural fluorspar can be reacted, as well as synthetic calcium fluoride, e.g., from calcium fluoride and optionally calcium carbonate containing solids from treating a waste gas or waste water with basic calcium compounds to remove contained HF.

The present invention concerns a process for the preparation of hydrogen fluoride from fluorspar or synthetic calcium fluoride, for example, calcium fluoride containing waste material.

It is well known that hydrogen fluoride (HF) can be prepared from calcium fluoride. Source is naturally occurring fluorspar, a natural mineral, which is reacted with more or less concentrated sulfuric acid or even oleum.

For example, U.S. Pat. No. 3,825,655 discloses a process for producing HF from fine-grained calcium fluoride with an excess of sulfuric acid. U.S. Pat. No. 3,469,939 discloses a process wherein concentrated sulfuric acid is sprayed through a nozzle onto fine-grained fluorspar in a reactor. EP-A-0 163565 (GB 2159136) discloses a process wherein fluorspar and sulfuric acid are reacted in a pre-mixer or a pre-reactor to produce a pulverized product with a conversion of about 40 to 50%; this pulverized product is then heated to yield HF and calcium sulfate in a rotating kiln; per mol of fluorspar, 3 to 3.5 moles of calcium sulfate are recycled to the rotating kiln. Co-pending international patent application PCT/EP 2008/051212 describes a process for converting fines in the form of a suspension in sulfuric acid.

U.S. Pat. No. 2,846,290 discloses a process for the manufacture of HF from fluorspar and sulfuric acid wherein fine fluorspar particles, e.g. particles with a size of 4 μm, can be applied as starting material. The reaction is performed in the presence of a diluent. Trichlorobenzene, especially 1,2,4-trichlorobenzene, is stated to be a satisfactory medium.

U.S. Pat. No. 3,718,736 discloses a process for the manufacture of HF from fluorspar and sulfuric acid wherein 3 parts or more of anhydrite per part of anhydrite produced in the reaction are recycled into the reactor.

U.S. Pat. No. 3,878,294 discloses a process for the manufacture of HF from particulate fluorspar and sulfuric acid. The fluorspar is preheated to 500 to 800° C. before it is contacted with sulfuric acid.

It can be observed during processing of fine-particulate starting material, be it fines from waste material containing calcium fluoride, or fluorspar comprising fines, that problems arise when a reaction with sulfuric acid was performed, especially if the reaction was conducted in a rotating kiln. For example, the reaction mixture initially is liquid, but solidifies and bakes together thus preventing transport in a rotating kiln.

Additionally, it was found that the fines of natural fluorspar contain a higher level of carbonate (often calcium carbonate) than is contained in the coarser fluorspar particles. When reacted with sulfuric acid, carbonate forms carbon dioxide gas. The reaction between fluorspar and sulfuric acid in conventional reactors is disturbed by this gas. Fines from waste fluid treatment often contain a very high level of carbonate and thus could not be worked up in conventional equipment.

Consequently, fines which were removed before reacting fluorspar with sulfuric acid, and fines obtained in waste fluid treatment were dumped, which means that a loss of valuable raw material results.

The process of the present invention solves these and other problems of the state of the art.

According to the present invention, a process is provided wherein calcium fluoride substantially in the form of fines as starting material is reacted with sulfuric acid with the proviso that the content of sulfuric acid in the reaction mixture is kept in an amount of equal to or less than 20% by weight. This means that throughout the reaction, the amount of sulfuric acid does never exceed 20% by weight of the total weight of the reaction mixture. To achieve a high speed of reaction, the concentration of sulfuric acid is preferably equal to or higher than 5% by weight. In this manner, the reaction mixture does not become corrosive, does not agglomerate and does not form a paste-like material which afterwards may solidify and thus block reactor internals. To the contrary, it remains fluidizable and can be agitated by simple mechanical means. Suitable means are, for example, internals inside the reactor. As internals, fixed or flexible means are suitable, for example, shuffle-like internals fixed to the wall of the reactor, or rotating or otherwise movable paddles. The process can be performed, for example, in simple mixers, fluidized bed reactors, in a rotating reactor with reactor internals or in a reactor with rotating screws or paddles. It is advisable that carbon dioxide which is formed can be drawn off from the reactor.

Preferably, no 1,2,4-trichlorobenzene is added or present; more preferably, no trichlorobenzene is added or present; still more preferably, no inert liquid diluent is added or present.

In preferred embodiments, the starting material contains a basic calcium compound, and/or a basic calcium compound is added to provide at least a part of the energy needed for reaction. Of course, additional sulfuric acid is needed for such starting material to convert not only the fluorspar, but also the basic calcium compound into calcium sulfate. Usually, the additional amount of sulfuric acid corresponds to a range of ±5% by weight to the amount stoechiometrically needed to convert the basic calcium compound to calcium sulfate.

The process can be performed in a very flexible manner. It can be performed batch wise or continuously.

There are several embodiments for the way the batch wise process can be performed.

According to one embodiment, sulfuric acid is added in an amount sufficient to react with essentially all the carbonate (mostly or completely calcium carbonate) present under formation of carbon dioxide. The amount needed can be calculated after analysis of the fines to determine, for example, the carbonate content, or simple tests can be performed monitoring the carbon dioxide evolution. Here, sulfuric acid is added portion wise or continuously in amounts so that the reaction mixture remains fluidizable. The reaction product which is calcium fluoride essentially free of carbonate can be added to fluorspar of any particle size for further conversion to calcium fluoride and HF in a subsequent reaction with sulfuric acid.

In another embodiment of a batch wise reaction, sulfuric acid is added in an amount sufficient to convert the carbonate contained into fluoride and also to convert at least a part or even all of the calcium fluoride originally present or formed, e.g. from the carbonate present or added, into calcium sulfate and HF. Also in this embodiment, sulfuric acid is added in an amount so that the reaction mixture remains fluidizable.

In the batch wise reaction, if fluorspar and sulfuric acid are reacted, the reaction starts usually with a conversion of 0 and ideally ends with a complete conversion (100%). But of course, one might as well start with, for example, a reaction mixture which contains equal to or more than 40% by weight of calcium sulfate.

Preferably, the reaction is performed continuously. In the embodiment of this invention wherein a continuous mode is performed, the content of calcium sulfate in the reaction mixture is regulated such that throughout the reaction, at least 40% by weight of the reaction mixture are constituted by calcium sulfate. Preferably, equal to or more than 50% by weight, especially preferably, equal to or more than 60% by weight, of the reaction mixture is constituted by calcium sulfate. In this manner, the phase of low conversion which is considered to be very corrosive and to have further disadvantages (e.g. baking) is avoided.

It has to be noted that the lower range of the concentration of calcium sulfate should be present throughout the complete reaction mixture because it is desirable that any partial volume of the reaction mixture remains fluidizable. As to the upper range, it is desirable that there is a concentration gradient throughout the reaction mixture. In those partial volumes of the reaction mixture which are withdrawn from the reactor as final product, the content of calcium sulfate should be as high as possible; though it must not necessarily be 100% because, as mentioned below, a residual content of calcium fluoride may even be advantageous for some purposes for which the calcium sulfate is applied. In those partial volumes to which sulfuric acid and fines are added to be reacted with each other, the content of calcium sulfate is preferably equal to or less than 96% by weight; more preferably, it is equal to or less than 90% by weight.

In the continuous mode, sulfuric acid and fines are added into the reactor continuously. The amount of sulfuric acid is adjusted such that at most, 20% by weight of the reaction mixture are constituted by sulfuric acid to keep the mixture fluidizable. Of course, the sum of sulfuric acid, dissolved HF, calcium sulfate, and possibly present intermediates (e.g. hemihydrate) in the reactor add up to 100% by weight.

To start the continuous reaction, calcium sulfate may be filled into the reactor in the desired amount, and then, introduction of fines and sulfuric acid is started. Alternatively, the reactor can be operated in a batch mode by filling in fines, slowly adding sulfuric acid and performing the reaction without removing reaction product from the reactor until the desired degree of conversion is achieved. Then, fines are also added, and the continuous mode starts. Thus, in this embodiment, no calcium sulfate (anhydrite) is recycled or introduced into the reactor.

The continuous reaction is best performed in a reactor wherein the fines and sulfuric acid are added at a certain part of the reactor interior, and the reaction mixture is transported to another part where the reaction product is drawn off from the reactor. The reaction takes place during the time the reaction product is moved from the point of addition of the reactants to the point the reaction mixture is drawn off. Suitable reactors are, for example, mixers known as “Lödige” mixers. Such mixers have internals and are rotating.

Considering the overall reaction between fluorspar and sulfuric acid, it is advisable to apply at least 95%, preferably at least 100% of the sulfuric acid stoechiometrically needed to convert all of the calcium fluoride into HF and calcium sulfate. Often, more sulfuric acid than stoechiometrically needed is applied. For example, sulfuric acid can be applied in an excess of up to 20% by weight or even more. To neutralize this excess, calcium oxide, calcium hydroxide or calcium carbonate can be added after the reaction to the formed calcium sulfate (anhydrite) to neutralize this excess. It has to be noted that often, the reaction of calcium fluoride with sulfuric acid to form HF and calcium fluoride must not necessarily be performed until 100% conversion are achieved. A minor percentage of unreacted calcium fluoride, e.g. 2% by weight or less, remaining in the formed calcium sulfate is often even desired.

The process of the present invention is preferably performed with starting material wherein the content of fines is equal to or greater than 90% by weight, preferably equal to or greater than 95% by weight or is even 100% by weight. The fines are preferably applied in dry or dried form (water content preferably less than 0.5% by weight).

The content of calcium fluoride in the fines which can be treated according to the process of the present invention is very variable. For example, in the fines of natural fluorspar, the CaF₂ content is usually very high, for example, between 90 and 95% by weight or even higher. In fines obtained by precipitation in, for example, waste gas or waste water treatment, the content of calcium fluoride may be as low as 50% by weight (relative to the dry mass) and even lower. Fines with calcium fluoride content between these values can likewise be treated. Also, the possible content of other constituents is very variable. For example, in fines of natural fluorspar, the content in carbonate (especially calcium carbonate) is rather low, e.g. between 1 and 4% by weight. In precipitated fines originating from waste treatment, it can be quite high, e.g. 5 to 25% by weight or even more. If desired, as mentioned above, calcium carbonate or other basic calcium compounds, e.g. calcium oxide, may be added deliberately. The process of the present invention can be performed with fines containing carbonate in a broad range going even beyond the limits given above. If calcium sulfate is present, this does not disturb the reaction, to the contrary: as mentioned above, a high level of calcium sulfate is desirable at least in the continuous operation.

Also silicon oxide can be present in the fines. Since silicon dioxide reacts with HF to form SiF₄, it is preferred that the content in silicon dioxide in the fines is preferably equal to or lower than 5% by weight, and more preferably, equal to or lower than 2% by weight (relative to the dry mass).

As source for sulfuric acid, it is possible to use oleum (i.e. sulfuric acid with a content of SO₃). Preferably, sulfuric acid with a H₂SO₄ concentration of equal to or more than 90%, preferably equal to or more than 95% by weight is applied. Preferably, the concentration of the sulfuric acid is equal to or less than 100% by weight. Sulfuric acid with an H₂SO₄ concentration in the range of 90 to 100° C., preferably 95 to 100%, is highly suitable. Often, concentrated sulfuric acid is applied which has a concentration of 98%±0.5% by weight of H₂SO₄. Such a sulfuric acid is much cheaper than oleum.

The term “fines” denotes preferably particles with an x90 value of equal to or less than 30 μm, preferably less than 27 μm. The particle size curve can be measured by laser diffraction, e.g. with a Helos Sympatec® apparatus. The term “x90 equal to or less than 30 μm” means that 90% of all particles have a size equal to or lower than 30 μm.

Natural fluorspar which was concentrated, especially by flotation, is very suitable as starting material for the treatment process of the present invention.

Preferably, the fluorspar is not preheated to about 500 to 800° C. and then reacted in this preheated form. More preferably, it is not preheated to a temperature equal to or higher than 400° C. Most preferably, it is not preheated to a temperature equal to or higher then 300° C.

According to one embodiment, fines from natural fluorspar can be treated. As mentioned above, such fines, if present in the starting material of the HF production process, are considered troublesome and are removed prior to the known treatment processes, for example, by sieving or other means, e.g. by wind classification which may be performed in a cyclone or during a drying operation. The fines up to now are considered as waste and are dumped. With the present invention, it is now possible to convert these fines which are in principle a valuable raw product into HF and calcium sulfate.

It was found that, to achieve complete reaction, it may be necessary to supply heat. Heat can be supplied from external sources. Alternatively, or additionally, at least a part of heat, or all the heat needed, is provided by adding basic calcium compounds, for example, calcium oxide, calcium hydroxide or respective lye, or calcium carbonate to the fines to be treated. These basic calcium compounds react with sulfuric acid and provide sufficient reaction heat to support the reaction between the fines and sulfuric acid. This will be explained in detail further below.

In another embodiment, fines can be treated which contain or consist of synthetic precipitated calcium fluoride. Preferably, the synthetic calcium fluoride is obtained from the treatment of fluoride containing waste gas or waste water, especially preferably from the treatment of HF containing waste gas or waste water.

For example, precipitated calcium fluoride in the form of fines obtained from purification of HF-containing waste gas or waste water with basic calcium compounds can be treated. Often, calcium oxide, calcium hydroxide or respective lye, or calcium carbonate is used as purifying agent for HF removal from waste water or waste gas. The respective calcium compound is converted to calcium fluoride which precipitates, often in the form of fines. If desired, the basic calcium compound can be applied until it is completely converted into calcium fluoride. In many cases, the conversion is stopped before conversion is quantitative, for example, for safety reasons to prevent breakthrough of unpurified waste gas or waste water. Here, the basic calcium compound is substituted by fresh purifying agent before complete conversion, and consequently, some basic calcium salt remains in the spent agent. To supply heat for supporting the reaction, basic calcium compounds may be added to the fines unless the fines do not already contain sufficient amounts thereof.

The waste gas or waste water can be originating from glass etching by means of HF, from HF production by the reaction between fluorspar and HF, from purifying waste gases from semiconductor manufacture or from phosphate fertilizer production. Other sources for HF containing waste gas or waste water which can be purified by scavenging HF with basic calcium salts are aluminium smelting, steel production, enamel, brick and ceramic manufacturing, glue and adhesives production.

The process according to the present invention can be applied to fines with very variable specific surface. Fines with a very low specific surface, e.g. equal to or greater than 1 m²/g (determined using N₂, e.g. with an AREA-matt II apparatus) can be treated. For example, fines from natural fluorspar often have a low specific surface. It generally takes a longer time to achieve a complete conversion of fines with low specific surface then in the case of fines with higher specific surface.

Thus, the process of the present invention is especially well applicable to fines with a specific surface of equal to or greater than 2.5 m²/g, more preferably, with a specific surface of equal to or more than 5 m²/g. The upper limit is not critical. For example, calcium fluoride with a specific surface of 20 m²/g and more, e.g. about 25 m²/g or even higher, can be treated. For fines with such high surface, usually obtained during a precipitation process, a 100% conversion to calcium sulfate and HF takes place even at ambient temperature.

As mentioned above, the reaction between sulfuric acid and calcium fluoride is advantageously supported by heating. The heat needed can be supplied by heating means. For example, reactor walls can be heated in a known manner, by burners, electrically or superheated steam. In a preferred embodiment, basic calcium compounds are comprised in the starting material. Preferred basic calcium compounds are calcium oxide, calcium hydroxide and calcium carbonate. Calcium carbonate is the most preferred basic calcium compound. They basic calcium compounds react exothermically with sulfuric acid to form calcium sulfate and thus deliver the heat needed to induce a reaction between calcium fluoride and sulfuric acid in the starting material. Basic calcium compounds can be added to the starting material, for example, to natural fluorspar, or to fines from waste gas or waste water treatment steps. In other starting materials, they are already contained, for example, in waste water or waste gas treatment agents where the conversion of the respective basic calcium compound to calcium fluoride was not quantitative. Generally, the temperature is equal to or higher than room temperature. Often, the reaction is performed at a temperature equal to or higher than 100° C. Preferably, the temperature is equal to or lower than 240° C.

In a preferred embodiment, no external heat is supplied in the treatment step. In this case, the amount of calcium oxide, calcium hydroxide or calcium carbonate in the starting material serves a heat source through its reaction with sulfuric acid. The content of the basic calcium salt is selected such that sufficient heat is provided. The necessary minimum amount can be determined easily by respective trials to find out if the reaction between calcium fluoride and sulfuric acid was complete. For fines with a high specific surface, the amount needed is very low because such fines are very reactive. Often, the content of basic calcium salt is preferably equal to or greater than 20% by weight, based on the total weight of the starting mixture (sum of basic calcium salt and fines). Preferably, it is equal to or less than 40% by weight. Of course, it might be even higher. The basic calcium compound can be added to the material to be treated insofar as it is not already present. The percentages given in this paragraph are relative to the sum of calcium fluoride and the basic calcium compound set to be 100% by weight.

The resulting calcium sulfate, if desired after neutralization of any excess sulfuric acid, is useful as construction material. The resulting reaction gases contain HF, SO₃, H₂O (gaseous), often also CO₂, H₂S and SiF₄ and possibly other minor reaction products. HF is recovered in a known manner. Often, the reaction gases are treated in washers operated with hot sulfuric acid. Further purification can be achieved by distillation.

It is an advantage of the invention that calcium fluoride containing fines, from natural sources or synthetically prepared, can be treated in a technically feasible way. Thus, fines which were dumped can now be applied as valuable source for HF.

The following examples further explain the invention without intending to limit it.

### EXAMPLES

### Example 1

### Determination of Basic Influencing Parameters

General procedure: 25 ml of sulfuric acid with a concentration of H₂SO₄ of 96.2% by weight were given into a container made from polytetrafluoroethylene (PTFE) coated with an aluminium coating (to improve heat transfer) and comprising a magnetic stir bar. The container was then positioned on the heated plate of a magnetic stirrer. Test samples which were dried 2 hours at 120° C. For each test, 0.5 g of a test sample was added slowly to the hot sulfuric acid. If the reaction temperature was achieved, a stop watch was started to determine the reaction time. After the desired reaction time, the hot reaction mass was given into an ice cooled metal bowl wherein the reaction mixture cooled immediately, and the reaction stopped. The cooled reaction mixture was then contacted with water, filtered and dried at 120° C. for two hours. The resulting product was then analyzed by roentgen fluorescence analysis (Bruker axs S4 Explorer). From the resulting data, the conversion of CaF₂ could be calculated.

(Remark: It has to be noted that these experiments differed from the invention insofar as the amount of sulfuric acid is much higher than provided in the process of the present invention. The experiments were performed to test the reactivity of starting material with different particles sizes, from different sources, and with different specific surface.)

TABLE 1
Composition¹ of the examined materials (dried samples)

| | Solidified | Sludge from HF | Natural | Fluorspar |
|---|---|---|---|---|
| Chemical | sludge² | production³ | fluorspar | dust⁴ |
| formula | (“Ps”) | (“Neutra”) | (“Nf”) | (Dust”) |
| CaF₂ | 89 | 53 | 97 | 93 |
| CaCO₃ | 5-6 | 24 | 1 | 2-3 |
| SiO₂ | 3 | 2-3 | 1 | 2-3 |
| CaSO₄ | 1 | 11 | — | — |
| Fe₂O₃, MgO, . . . | <1 | <1 | <1 | <1 |
| Al oxide/salts | <1 | 6-7 | — | — |

¹Given in mass-%
²From HF removal during glass treatment reactions
³From neutralizing treatment of waste water obtained in HF production from CaF₂/H₂SO₄
⁴Fines removed from natural fluorspar in a cyclone

Test results are compiled in table 2. For each test, the respective test number, test material, specific (BET-) surface in m²/g (if determined), reaction temperature (in ° C.), Reaction time (in seconds) and conversion (in % relative to CaF₂ contained) are given.

TABLE 2
Results of tests with different fines

| Test | Examined | Specific | Reaction | Reaction | |
|---|---|---|---|---|---|
| Number | material | surface | temperature | time | Conversion |
| V1 | Ps | 17.3 | 179 | 420 | 100 |
| V2 | Ps | | 193 | 420 | 100 |
| V3 | Ps | 3.34 | 214 | 240 | 99 |
| V4 | Ps | | 230 | 240 | 100 |
| V5 | Ps | 5.17 | 170 | 210 | 99 |
| V6 | Ps | 5.89 | 170 | 180 | 99 |
| V7 | Ps | 4.92 | 162 | 130 | 99 |
| V8 | Ps | 8.74 | 25 | 420 | 97 |
| F5 | Ps | 10.88 | 27 | 420 | 98 |
| V9 | Ps | 2.9 | 180 | 210 | 99 |
| V10 | Ps | 4.45 | 160 | 210 | 99 |
| V11 | Ps | 3.52 | 139 | 210 | 99 |
| V12 | Ps | 10.5 | 25 | 420 | 100 |
| F3 | Ps | | 26 | 420 | 98 |
| | (free of | | | | |
| | CO₃²⁻) | | | | |
| F6 | Dust | 5.43 | 26 | 420 | 42 |
| F4 | Natural | 0.18 | 25 | 420 | 0.1 |
| | fluorspar | | | | |
| V14 | Neutra | 18.44 | 25 | 420 | 82 |
| C21 | Precipitated | | 27 | 420 | 100 |
| | CaF₂ | | | | |
| V17 | Ps, dried | | 26 | 420 | 98 |
| | at 500° C. | | | | |
| C4.1 | Precipitated | | 25 | 420 | 98 |
| | CaF₂ | | | | |
| C4.2 | Precipitated | 2.92 | 27 | 420 | 93 |
| | CaF₂, | | | | |
| | dried at | | | | |
| | 500° C. | | | | |

The results demonstrate the general tendency that the higher the specific surface, the higher is the resulting conversion and/or the lower the contact time and/or the lower the temperature needed for good conversion. A test with a sample dried at 1000° C. gave only low conversion. (It has to be noted that the samples dried at 1000° C. were not introduced into the reactor with this high temperature, but they were cooled before applying them. Thus, this pretreatment to dry the particles is different from the process of U.S. Pat. No. 3,878,294 where the particles are heated to about 500 to 800° C. and introduced that hot into the reaction.)

### Example 2

### Simulation of a Fluidized Bed Reactor

General procedure: The conditions in a fluidized bed (a fluidized bed is provided mechanically; the intensive mixing of the starting materials results in a short residence time and high throughput in a continuous mode of operation) after a certain conversion (presence of calcium sulfate and sulfuric acid in varying amounts) are simulated in the magnetically stirred PTFE container used in example 1.

About 10 g calcium sulfate (anhydrite) and the respective amount of sulfuric acid were thoroughly mixed, put into the container and heated. If a temperature of 180° C. was reached, the test material was added in an amount which—under the assumption of 100% selectivity—converts exactly 50% of the sulfuric acid contained in the reaction mixture. After a certain reaction time, the reaction was stopped and the conversion was determined as described above. Solidified sludge was applied as test material.

The respective data (weight of sludge (“Ps”) and anhydrite in g, reaction temperature in ° C., reaction time in seconds, conversion in % and content of sulfuric acid in weight-% in the starting material) are compiled in table 3.

TABLE 3

| | | | Temper- | Reaction | Conver- | Content |
|---|---|---|---|---|---|---|
| No. | Ps | Anhydrite | ature | time | sion | H₂SO₄ |
| A4 | 0.50 | 10.00 | 180 | 300 | 100 | 11.1 |
| A5 | 0.50 | 10.00 | 180 | 150 | 99 | 11.3 |
| A6 | 0.50 | 10.00 | 180 | 600 | 98 | 11.1 |
| A7 | 0.50 | 10.00 | 180 | 300 | 100 | 11.1 |
| A8 | 0.50 | 10.02 | 180 | 300 | 33 | 5.3 |
| A10 | 0.50 | 10.03 | 180 | 300 | 13 | 1.2 |
| A11 | 0.75 | 10.09 | 180 | 300 | 100 | 15.2 |
| A12 | 1.00 | 10.05 | 180 | 300 | 100 | 19.9 |
| A13 | 0.38 | 10.01 | 180 | 150 | 87 | 7.5 |

The examples principally demonstrate that the reaction can be performed in a fluidized bed because in the range up to 20% by weight of sulfuric acid contained, no agglomeration (or, in the upper concentration range, no hindering agglomeration) was observed. The content of sulfuric acid should be equal to or greater than 5% by weight, preferably equal to or higher than 10% by weight to achieve good conversion. Of course, a higher conversion with low sulfuric acid concentration would be possible applying an extended reaction time.

### Example 3

### Fines of Natural Fluorspar as Starting Material in a Mixer (Batch Process)

The reaction can be performed in a plow share mixer of Lödige. For supply of sulfuric acid directly into the reactor, a lancet or injector can be used.

Dust separated from natural fluorspar (which contains only minimal amounts of calcium carbonate) is mixed with calcium carbonate to a content of about 20% by weight of the latter and put into the reactor. No external heat is required. Concentrated sulfuric acid is injected in intervals or continuously into the reactor so that the H₂SO₄ content in the reaction mixture does not exceed 16% by weight. Resulting gaseous components are passed through a washer filled with sulfuric acid. The pre-purified gas mixture leaving the reactor is then distilled to obtain purified HF. After the addition of 105% of the stoechiometrically needed amount of sulfuric acid, the reaction mixture is removed from the mixer after a post reaction phase; calcium carbonate is added to neutralize residual sulfuric acid.

Example 3 can be repeated to start a continuous reaction. In a first step, sulfuric acid is supplied to the reactor until about 80% of the stoechiometrically needed amount of sulfuric acid is added. Then, continuously, sulfuric acid and fines (and, if not contained sufficiently in the fines, calcium oxide) are added to the reactor. Hereby, sulfuric acid and fines are added at the same part of the reactor to achieve a good mixing of them. The reaction mixture is transported during the rotation of the mixer to another part of the mixer where reacted product is continuously drawn off. Reaction takes place during the movement from the inlet of the acid and fines to the outlet of the reacted product.

### Example 4

### Fines of Neutralization Sludge as Starting Material in a Fluidized Bed Reactor

Example 3 is repeated. Since the dried neutralization sludge (obtained by treating HF-containing waste water with calcium carbonate) contains 24% by weight of calcium carbonate per se, no addition of calcium carbonate is needed. Resulting HF and anhydrite are treated as in example 3.

### Example 5

### Fines of Natural Fluorspar as Starting Material in a Fluidized Bed Reactor

Example 3 is repeated. No calcium carbonate is added this time, but the reactor and its contents are heated to 180° C. during the addition of sulfuric acid. Isolation of HF and anhydrite is performed as described in example 3.

1. A process for the preparation of hydrogen fluoride comprising reacting calcium fluoride substantially in the form of fines as starting material with sulfuric acid in a reaction mixture with the proviso that the content of sulfuric acid in the reaction mixture is kept in an amount of equal to or less than 20% by weight of the total weight of the reaction mixture.

2. The process according to claim 1 wherein sulfuric acid with a H₂SO₄ concentration equal to or greater than 90% by weight and equal to or less than 100% by weight is applied.

3. The process of claim 1 wherein no inert liquid diluent is present or added to the reaction mixture.

4. The process according to claim 1 wherein fines from natural fluorspar are used as starting material.

5. The process according to claim 1 wherein the starting material contains a basic calcium compound, and/or a basic calcium compound is added to provide at least a part of energy needed for the reaction.

6. The process according to claim 1 wherein synthetic calcium fluoride is used as starting material.

7. The process according to claim 6 wherein the synthetic calcium fluoride is obtained from treating a fluoride containing waste gas or waste water.

8. The process according to claim 7 wherein the synthetic calcium fluoride comprises a substantive amount of a basic calcium compound.

9. The process according to claim 1 wherein the sulfuric acid is not reacted with calcium fluoride being preheated to a temperature of from 500° C. to 800° C.

10. The process according to claim 1 wherein the reaction step is performed batch wise.

11. The process according to claim 5 wherein the ratio of the amount of sulfuric acid added and the amount stoichiometrically needed to convert the basic calcium salt and the calcium fluoride completely to calcium sulfate is about 1:1 to 1.2:1.

12. The process according to claim 1 wherein the reaction step is performed continuously.

13. The process according to claim 12 wherein the content of calcium sulfate in the reaction mixture is kept throughout the reaction mixture at an amount of equal to or greater than 40% by weight.

14. The process according to claim 12 wherein the content of calcium sulfate in a partial volume of the reaction mixture withdrawn from a reactor as final product is equal to or greater than 98% by weight.

15. The process according to claim 12 wherein the concentration of calcium sulfate in a partial volume of the reaction mixture to which sulfuric acid and fines are added to react with each other, is kept at equal to or less than 96% by weight.
